(19) United States
(12) Patent Application Publication
(10) Pub. No.: US 2012/0093092 A1
(43) Pub. Date: Apr. 19, 2012

(54) METHOD AND APPARATUS FOR RADIO CHANNEL MANAGEMENT

(75) Inventors: Mika Kasslin, Espoo (FI); Janne Marin, Espoo (FI); Zexian Li, Espoo (FI)

(73) Assignee: Nokia Corporation, Espoo (FI)

(21) Appl. No.: 12/907,100

(22) Filed: Oct. 19, 2010

(51) Int. Cl. H04W 72/04

(52) U.S. Cl. 370/329

(57) ABSTRACT

In a non-limiting and exemplary embodiment, a method is provided for radio channel management, comprising: receiving, by a mediating node, a request from a mobile terminal for available white space channels, sending a request for available channels to an entity having access to a white space database with information on available white space channels, receiving information indicating a set of available white space channels from the entity, reserving at least one of channels in the set of available channels for further use, and providing a sub-set of the channels of the set of available channels to the mobile terminal.

### FIELD OF THE INVENTION

The present application relates generally to radio channel management, and further to management of white space channels.

### BACKGROUND OF THE INVENTION

Vacant television frequencies, often referred to as TV white spaces, have been allowed for use on an unlicensed basis in many geographical areas. These TV white spaces are frequency channels allocated for television broadcasting that will not be used in given geographic areas. Many proposals exist for using the TV white space (TVWS) spectrum. For example, it has been suggested that Wireless Regional Area Networks (WRANs) could be established to provide high-speed internet access with a larger coverage.

Currently the basic rules from the Federal Communications Commission (FCC) for TVWS operations in the US on secondary basis specify that a network can be initiated only by a Mode II personal/portable or a Fixed device that accesses a data base to check available channels based on the geographical location of the device. Such devices may be referred generally as master devices. The master device can initiate a network in one of the available channels and it can provide the list of available channels for clients or Mode I personal/portable devices (the term used in the FCC rules for client devices). A client device is a device that cannot initiate a network but operates under control of a master device. It needs to receive a transmission from a master in order to transmit in a TVWS channel. The client can transmit in any available channel indicated by the master.

Data communication within wireless local area networks (WLANs) is now typically accomplished by using one of the IEEE 802.11 standards. The 802.11b and 802.11g standards are designed to operate in the 2.4 GHz band using direct sequence spread spectrum (DSSS) and orthogonal frequency division multiplexing (OFDM) technologies. The 802.11a standard is designed to operate in the 5 GHz band using OFDM technology. The 802.11n standard is designed to operate in the 2.4 GHz or the 5 GHz bands.

IEEE 802.11af task group has been set up to define a standard for use of Wi-Fi technology in TV white spaces. This enables additional bandwidth for Wi-Fi operations, and since an 802.11 system operating the TV white spaces would use frequencies below 1 GHz, this would allow for greater distances to be achieved for Wi-Fi devices.

### SUMMARY OF THE INVENTION

Various aspects of examples of the invention are set out in the claims.

According to a first embodiment, there is provided a method, comprising: receiving, by a mediating node, a request from a mobile terminal for available white space channels, sending a request for available channels to an entity having access to a white space database with information on available white space channels, receiving information indicating a set of available white space channels from the entity, reserving at least one of channels in the set of available channels for further use, and providing a sub-set of the channels of the set of available channels to the mobile terminal.

According to a second embodiment, there is provided an apparatus comprising at least one processor and at least one memory including computer program code, the at least one memory and the computer program code configured to, with the at least one processor, cause the apparatus at least to perform: cause sending of a request for available channels to an entity having access to a white space database with information on available white space channels, reserve for further use at least one of channels in a set of available white space channels indicated by the entity, and provide a sub-set of the channels of the set of available channels to a requesting mobile terminal.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates a system with cognitive radio resource user devices;

FIG. 2 illustrates a method according to an embodiment;

FIGS. 3a to 3c illustrate signaling examples according to some embodiments;

FIGS. 4 and 5 illustrate message formats according to some embodiments;

FIG. 6 illustrates an apparatus according to an embodiment.

### DETAILED DESCRIPTION

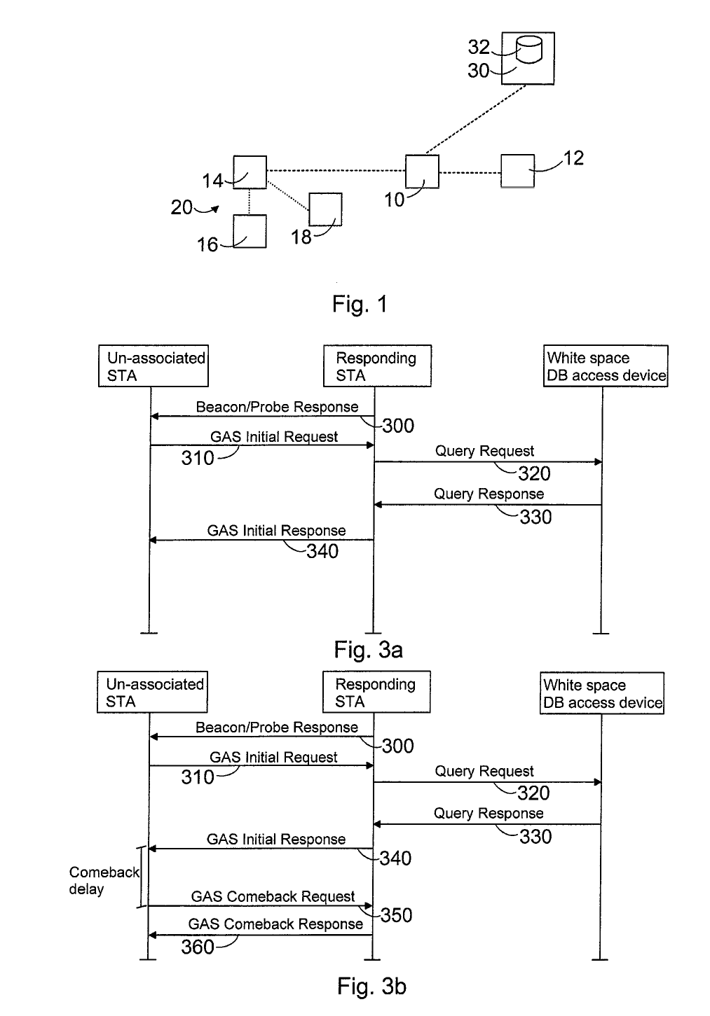

FIG. 1 illustrates entities related to usage of white space resource according to an example embodiment. References are made below to TVWS related example embodiments, but it is to be appreciated that the application of presently disclosed features are not limited to any specific frequencies or related techniques. The term “white space channel” is to be understood broadly, and cover channels reserved for licensed use but made available, for example, locally or temporarily for unlicensed use because not used by primary users. White space channels may be channels dedicated merely for local unlicensed use. However, white space channels may be used for coexistence of radios with different priorities, and refer to (shared band) channels in which primary users, such as TV stations, wireless microphones or cellular systems, may operate on licensed basis, but on which also secondary use by non-licensed secondary users, such as WLAN stations, is allowed (given that they do not interrupt transmissions of the primary users). The operation on white space channel(s) may be allowed for secondary use in a specific geographic location and may be allowed for a certain time period.

The illustrative and simplified system may comprise one or more wireless networks, such as a cellular or non-cellular radio access network (RAN), an IEEE wireless local area network, an ad-hoc network, a mesh network, or another network, capable of operating or supporting access establishment on one or more radio bands with white spaces, such as television white spaces, for instance. The wireless network may comprise a number of network elements and terminals connected to the wireless network. The example system of FIG. 1 further comprises at least one mediating node 10. The mediating node 10 is configured to communicate with at least one database (DB) access device 30 comprising or connected to a database 32 storing information at least on available white space channels, hereafter referred to as a white space database. The white space database 32 may comprise information on sub-bands or channels currently available in given geographical areas. For example, the database 32 may comprise indications, for each of the geographical areas covered by the database, of frequencies or channels currently not used by a primary system.

The mediating node 10 is configured to provide information on available white space channels to one or more further devices 12, 14. In particular, the mediating node 10 may be arranged to assist mobile terminals 14 not associated or registered to an access network to obtain the information on available white space channels to assist in network selection and deciding whether to initiate a new local network. The mobile terminal 14 may thus request information on available channels for secondary use from/via a network to which the terminal is not associated. The mediating node 10 may be a non-radio network related element, such as a server, or a radio access network element, such as an access point or a base station (controller) serving a number of mobile terminals. However, in another embodiment the mediating node 10 may be implemented by a set of devices or a mobile terminal device, which may function as a mesh node, for example.

The DB access device 30 is configured to receive information at least on white space channels available at a given geographical area from the white space database 32, such as the FCC TVWS database. The DB access device 30 may be responsible also for maintaining at least some information in the white space database 32 and/or a further database.

In view of local area communication/network establishment by applying a white space channel, a mobile terminal 14 may act as a master and initiate communications or a network 20 on white space channel(s) with one or more mobile communications devices 16, 18, which may be considered as client/slave or dependent devices. Before this, the master device 14 needs to obtain information of the available white space channels via the mediating node 10. On the basis of received information on available white space channels, the master device 10 may then initiate the network 20 on one of the available channels with one or more further devices 16, 18. It is to be noted that such (secondary) users of a given white space channel may be required to detect any primary user activity on the channel, by spectrum sensing or some other detection method, and avoid use of the channel during primary use.

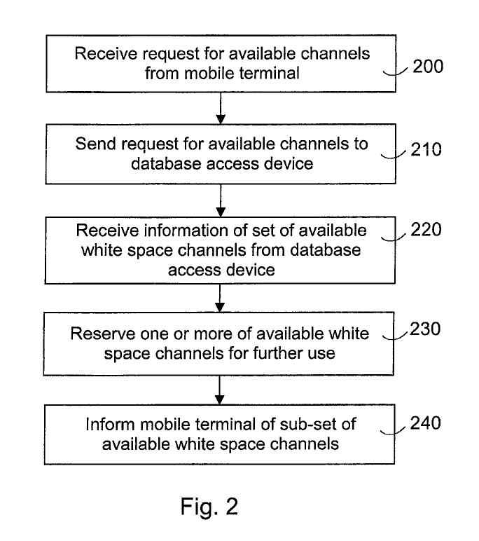

FIG. 2 illustrates a method, which may be carried out by the mediating node 10, for example. A request from a mobile terminal for available white space channels is received 200. In response to receiving the request from the mobile terminal, a request for available channels may be sent 210 to an entity, in the example of FIG. 1 the database access device 30, having access to a white space database with information on available white space channels. The request from the mobile terminal may be forwarded to the entity, or a new request may be generated on the basis of the received request.

Information indicating a set of available white space channels is received 220 from the entity. The information on available white space channels may be received as a list of available white space channels, as referred to in further example embodiments below. At least one of the indicated channels is reserved 230 for further use. The remaining sub-set of the indicated channels is provided 240 to the mobile terminal as a response to the request received in block 200.

The method of FIG. 2 enables a mediating device, such as an enabling WLAN AP, to reserve some of the available channels for its own use and/or use of other mobile communications devices, such as access points or terminals at the respective geographical area. Thus, the mediating node 10 may take advantage of the white space channel information it has acquired for a mobile terminal 14 for further use. For example, a further local wireless network is initiated by the mediating node 10 or another device 12 for which the mediating node indicates the available reserved channel.

It is to be appreciated that FIG. 2 illustrates an example of applying the present features related to informing the mobile terminal(s) on available white space channels, and various modifications and/or additions may be made to the procedure of FIG. 2. Further, it is to be appreciated that information on the available white space channels may be indicated in various ways, for example as a list indicating the numbers of the available channels, indication of the available sub-band, a frequency span, block or range, etc.

In one example variation, the mediating node 10 responds to the request (200) of the mobile terminal on the basis of white space channel information received from the DB access device 30 before reception of the request. This embodiment enables to provide the response to the mobile terminal faster, since the signaling with the DB access device 30 and the white space database access can be avoided at least in some cases.

The mediating node 10 may be arranged to send the request (210) to the DB access device 30 without specific request from a mobile terminal, for example periodically. In another example, after receiving white space channel information for a first mobile terminal, at least some of the received white space channel information may be responded to a subsequent request of a second mobile terminal. The mediating node 10 may be arranged to retain the received white space channel information as valid or stored for a predefined time period. Upon receiving a request of a mobile terminal, the mediating node 10 may retrieve earlier stored white channel information, and respond to the by the modified list (a pre-modified list may be obtained from the memory. In another embodiment, the mediating node may reserve (230) some of the channels of a list earlier stored in the memory upon request of the mobile terminal. Further, the mediating node 10 may be arranged to receive 200 requests from and/or provide white space channel information for a plurality of mobile terminals at a given geographical area by a single request to the DB access device 30. After receiving 220 the list of available channels, the mediating node may allocate the channels such that a first sub-set of available channels is allocated for a first requesting mobile terminal, a second sub-set is allocated for a second requesting mobile terminal, etc.

In addition to reserving 230 channels for further use, a filtering action for other reasons than reserving 230 a channel for further use may be performed on white space channel(s) of the received (210) list. In one example embodiment, the mediating node 10 filters a white space channel indicated as available on the basis of quality associated with the channel. For example, an access point functioning as the mediating node 10 may filter some channels if a non-AP device has in a measurement report indicated that the channel quality is poor.

In one embodiment, the mediating node 10 may be arranged to submit the list of available white space channels as such at least for the requesting mobile terminal. The mediating node 10 may be arranged to selectively submit either the originally received list or a list with the sub-set of channels. The decision may be made on the basis of current need of white space channels for other use by the mediating node 10 and/or the further mobile terminals, for example. In another embodiment, the mediating node 10 may send the originally received list of available white space channels and the list of sub-set of the available channels to the requesting mobile terminal.

Let us now study some further detailed embodiments related to applying at least some of the above indicated features. In some embodiments the devices 14, 16, 18 operate as WLAN stations (STA) and the intermediating node 10 is an access point (AP). Thus, a WLAN AP may provide access for WLAN STAs to the white space database 32 information in order to get information required for network initiation without requiring Internet connectivity from the WLAN STA. This will enable more versatile networking opportunities to apply further white space channels by WLAN capable devices, for example to establish small scale local device networks.

In an example embodiment applying the TVWS channels under FCC rules, a WLAN STA 14 that wants to initiate a network, such as a basic service set (BSS), independent basic service set (IBSS), or a Wi-Fi Direct group, by applying a TVWS channel, is considered as a master that needs to access the white space database information to check available channels based on its geographical location. A WLAN AP may carry out features illustrated herewith for the mediating node 10 and send 240 the modified white space channel list for the master WLAN STA.

In some embodiments, the devices 10, 14, 16, 18 are arranged to support one or more versions of the IEEE 802.11 specifications. In a further embodiment, the devices 10, 14 communicate to provide TVWS channel information for unassociated STA (14) under IEEE 802.11af enhancements. The mobile terminal 14 requesting the information on white space channels may thus be arranged to function as a dependent and requesting station capable of requesting location-based dependent station enablement (DSE) and transmit beacon frames to initiate its own network. The mobile terminal 16, 18 may be arranged to function as a non-beaconing station not allowed to initiate its own network.

However, it is to be appreciated that there may be a still further enabler, such as a server connected to the Internet, between the mediating node 10 and the DB access device 30 and serving as a gateway to the white space database 32 information. The enabler may advertise its white space database access service, and the mobile terminal 14 may request information on the available channels from the enabler via an interworking service provided WLAN AP. The enabler functionality may be collocated with an access point.

In an embodiment, a non-access point WLAN station may be provided with mediating node functionality and function as a mediating node for another (dependent) WLAN STA.

In some embodiments, the mediating node 10 may itself function as a master node and initiate a network. For example, a WLAN AP functioning as the mediating node may use a white space channel reserved 230 from the received list of white space channels to initiate a new network using white space channel(s). In another example, the WLAN AP informs one or more other WLAN APs or non-AP STAs on one or more available white space channels reserved in block 230, so that they can initiate a new network using white space channel(s).

In some embodiments, the mediating node 10 is arranged to advertise its capability to provide (access to) information on available white space channels periodically and/or upon request. For example, the mediating node 10 may be arranged to send an advertisement element indicating support for white space database access in a beacon or probe response frame.

In some embodiments features of generic advertisement service (GAS) specified by IEEE 802.11u are utilized for advertising white space database access and transferring information on the white space channels. Such GAS messages may be transmitted using individually-addressed Public Action management frames, which are Class-1 frames. Class-1 frames are frames that can be transmitted in un-associated state, such as Probe request frames by a STA in active scanning.

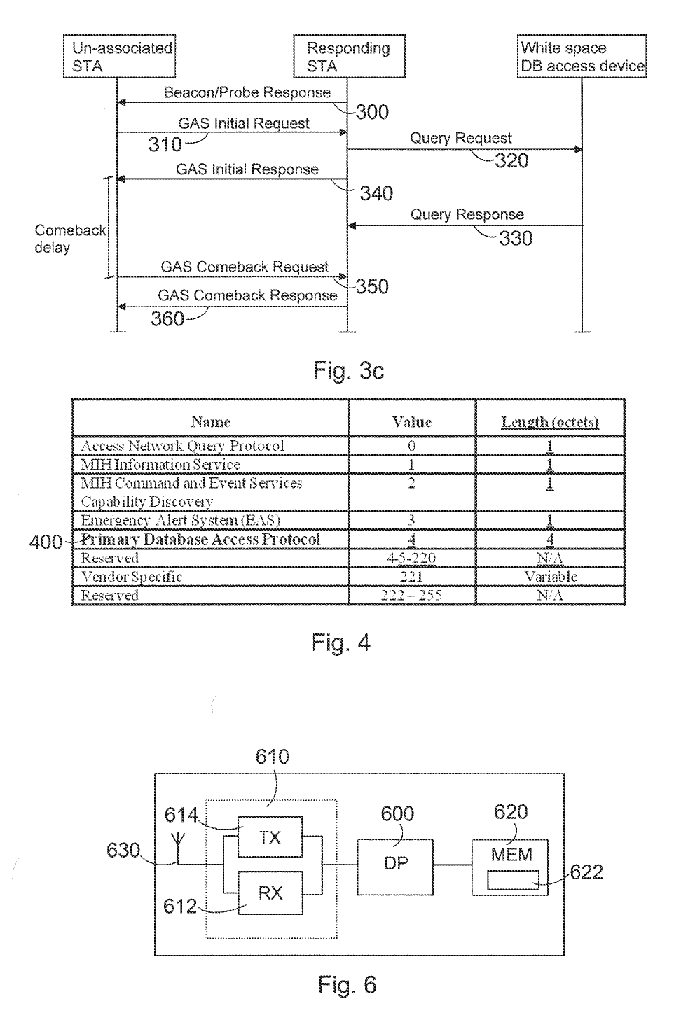

FIGS. 3a to 3c illustrate example signaling diagrams for applying GAS protocol and frames between an un-associated STA and a responding STA, in one embodiment AP. As illustrated in FIGS. 3a to 3c, the responding STA may function as the mediating node 10 and communicate with the DB access device 30 to provide the requesting STA with information from the white space database 32. In another embodiment, the responding STA may forward the request to a further (enabler) device operating as the mediating node 10.

An un-associated non-AP STA that has GAS protocol support can use the GAS procedures with an AP or another responding STA that indicates support for GAS protocol with presence an Interworking element in a Beacon or Probe Response frame 300. The Advertisement Protocol element in the Beacon or Probe Response frame indicates the Advertisement Protocol IDs supported. In addition to the currently specified protocol IDs, a further ID may be specified in the Advertisement Protocol element to indicate support for access to white space database of white space channels or a protocol.

A WLAN STA that wants to initiate a wireless network using an white space channel, for example on TVWS band, can thus use an AP as a gateway to a primary/FCC database if the STA detects an AP sending such advertisement in a Beacon or Probe Response frame 300. Once the STA has detected such an AP, it may issue a GAS Initial Request 310 to request (200) available channels for white space channels. After the responding STA receives the request frame from the requesting STA, it sends a request for available white space channels 320 to the white space database access device 30. Once the responding STA receives a response 330, it may provide a GAS Initial Response 340 to the requesting STA as per the GAS protocol. Before issuing the response frame 340, the responding STA may apply the procedures illustrated above e.g. in connection with blocks 230, 240 and provide only a subset of the channels indicated in the response 330 of the database access device 30. The GAS Initial Response 340 may comprise the (sub-set) of available channels.

FIGS. 3b and 3c also illustrate use of GAS Comeback frames 350, 360. The GAS Initial Response 340 may include a GAS Comeback Delay field, which specifies the delay time value in TUs. A zero value is included in the GAS Initial response 340 when a Query Response is provided in this frame. Upon expiry of this delay, the requesting (non-AP) STA should attempt to retrieve the Query Response using a Comeback Request Action frame 350, and the responding STA may provide the Query Response (with the white space channel information) in a GAS Comeback Response 360.

A new protocol, which may be referred to as a primary database access protocol (PDAP), for example, may be specified between the devices 10, 14 for facilitating access to the white space database 32 information for un-associated or non-registered mobile terminals. Such protocol may be specified as a protocol of its own within the GAS protocol and applying the messages illustrated in FIGS. 3a to 3c, for example. Such new database access protocol may be provided with a new protocol ID, which may be indicated in the Beacon and/or Probe Response frames 300 to indicate the support for the white space database access. FIG. 4 illustrates an example of an advertisement protocol element, which may be used under GAS protocol in the Beacon and/or Probe Response frames 300. A new identifier 400 may be allocated for the PDAP. The other five identifiers indicate protocols/services further defined by the IEEE 802.11u working group.

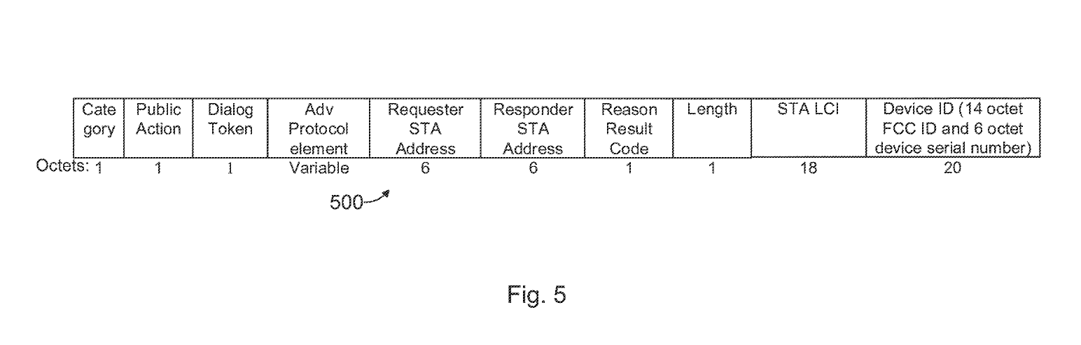

FIG. 5 illustrates an example of a frame 500 from a requesting un-associated STA. The frame may be applied as the request frame 310 for the PDAP protocol, for example. The Category, Public Action, and Adv Protocol element fields may be set to indicate PDAP. The Requester and Responder STA address fields indicate the requester/responder MAC addresses. The STA location identifier (LCI) is set by the requester to indicate its location. The Device ID field is set to indicate the requester's identity, which may be any identifier(s) required for the data base access purpose.

In addition to the list of available white space channels, further information related to the use of white space channels may be provided to (220, 330) and/or from (240, 340) the mediating node 10. In one embodiment, further validity information regarding the availability of the white space channels is provided. For example, some or all of the white space channels may be indicated to be available at specific times, until a specified time, or for a specified time period. Such time availability information may be specified in the information from the database 32 and/or the response of the mediating node.

In some embodiments, the mediating node 10 generates a white space map comprising the sub-set of the channels of the received list of available white space channels and sends the white space map to the mobile terminal in block 240. The white space map may comprise further information regarding the available channels, such as information on maximum allowed transmission power(s). In a further example embodiment on IEEE 802.11, the sub-set of the channels is included in a white space map element defined by the 802.11 of working group.

In some embodiments, a Registered Location Query Protocol (RLQP) is applied to enable an unassociated WLAN STA to obtain information on white space channels. The above illustrated GAS procedures and messages may be part of the RLQP. In on example variation, the responding STA operating as the mediating node 10 may be arranged to communicate with an RLQP advertisement server functioning as an enabler for dependent STAs. However, it will be appreciated that the above protocols and frames illustrate only some available options, and that the above-illustrated requests and responses to provide information on available white space channels may be implemented by some other protocols and/or frames.

According to an example use case, there may be an enterprise network which is managed and operated with a network management system/server. That system determines frequency channels for each AP/node. By applying at least some of the features illustrated above, it can also reserve or dedicate one channel, as an example, to device-to-device networks or ad-hoc networks. Similar approach could be applied with “visitor networks”. When an ad-hoc network is being requested through the mediating node that is a device in an enterprise network, the network management system may now force the new network to initiate itself in the dedicated channel.

In an embodiment, the white space database 32 stores information on cognitive radio (CR) channels for primary and/or secondary use. The list 220, 240 of available white space channels may be a list of available CR channels not used by primary users at a given location. In a further embodiment, at least some secondary users may make reservations of channels for secondary CR use in the DB 32 (or another database). Thus, the list 220, 240 of available channels may identify channels not reserved by secondary users.

In an embodiment, at least some of the above illustrated features are applied in connection with radio coexistence related features being developed under IEEE 802.19.1. A device configured to function as the mediating node 10 may comprise a coexistence enabler (CE) and the mobile terminals 14, 16, 18 may be secondary cognitive radio resource users and TV white space (network) devices. A CE can be an interface element in a network management server through which the server acquires information about the environment and the list of available white space channels. By applying at least some of the above-illustrated features, the server can manage the channel list and provide a sub-set of the channels to manage the network.

In an embodiment, a device configured to function as the mediating node 10 may comprise a coexistence manager (CM) arranged to make TVWS coexistence related decisions and support in exchange of coexistence related information. In a further example embodiment, the mediating node 10 device may be arranged to function as the coexistence manager CM controlling local secondary TVWS spectrum use. For example, such device may apply at least some of the features illustrated above for the mediating node 10 and reserve (230) and allocate available TVWS channels to different TVWS devices and provide (240) information on available TVWS channels for further logical entities.

FIG. 6 is a simplified block diagram of high-level elements of an apparatus according to an embodiment. The apparatus comprises a data processing element DP 600 with at least one data processor and a memory 620 storing a program 622. The apparatus may be configured to function as the mediating node 10, such as an WLAN access point supporting IEEE 802.11 of and carry out at least some of the functions illustrated above for the mediating node 10.

The memory 620 may comprise non-volatile portion, such as EEPROM, flash memory or the like, and a volatile portion, such as a random access memory (RAM) including a cache area for temporary storage of data, and implemented using any suitable data storage technology suitable for the technical implementation context of the respective entity. The data processing element 600 may be of any type suitable to the local technical environment, and may include one or more of general purpose computers, special purpose computers (such as an application-specific integrated circuit (ASIC) or a field programmable gate array FPGA), microprocessors, digital signal processors (DSPs) and processors based on a multi-core processor architecture, as non-limiting examples.

The apparatus may comprise at least one radio frequency transceiver 610 with a transmitter 614 and a receiver 612. The apparatus of FIG. 6 may be arranged to use licensed and/or unlicensed bands. It should be appreciated that the above-illustrated embodiments provide only examples of some radio technologies in which the features related to applying dedicated channels may be applied. For example, the device may operate in accordance with wireline protocols, such as Ethernet and digital subscriber line (DSL), with second-generation (2G) wireless communication protocols, such as GSM, with third-generation (3G) wireless communication protocols, such as 3G protocols by the 3GPP, CDMA2000, WCDMA and time division-synchronous CDMA (TD-SCDMA), with fourth-generation (4G) wireless communication protocols, such as 3GPP LTE, wireless local area networking protocols, such as 802.11 and/or 802.19, short-range wireless protocols, such as Bluetooth, and/or the like. In some cases the apparatus may be provided with software defined radio having only one transmitter and receiver and digital processing of different radio protocols. A single chip may be configured to provide two or more radio technologies.

Embodiments of the present invention may thus be implemented in software, hardware, application logic or a combination of software, hardware and application logic. In an example embodiment, the application logic, software or an instruction set is maintained on any one of various conventional computer-readable media.

In the context of this document, a “computer-readable medium” may be any media or means that can contain, store, communicate, propagate or transport the instructions for use by or in connection with an instruction execution system, apparatus, or device, such as a computer, with some examples of a computer being described and depicted in connection with FIG. 6. A computer-readable medium may comprise a tangible and non-transitory computer-readable storage medium that may be any media or means that can contain or store the instructions for use by or in connection with an instruction execution system, apparatus, or device, such as a computer.

The program 622 may comprise computer program instructions that, when executed by a data processor 600, enable the apparatus to operate in accordance with at least some of embodiments of the present invention. The program may comprise computer program code configured to, with the at least one processor, cause the apparatus to perform at least some of the features illustrated in connection with FIGS. 1 to 5.

The apparatus could be in a form of a chip unit or some other kind of hardware module for controlling a radio device. The hardware module may form part of the device and could be removable. Some examples of such hardware module include a sub-assembly or an accessory device. It will be appreciated that the apparatus may comprise various further elements, such as further processor(s), further communication unit(s), user interface components, a GPS or another positioning system device, a battery, and a user identity module, not discussed in detail herein.

Although the apparatus and the data processing element 600 are depicted as a single entity, different features may be implemented in one or more physical or logical entities. There may be further specific functional module(s), for instance for carrying one or more of the features described in connection with FIG. 2.

In one example embodiment, there may be provided circuitry or user interface circuitry configured to provide at least some control functions illustrated above. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

If desired, at least some of the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
receiving, by a mediating node, a request from a mobile terminal for available white space channels,
sending a request for available channels to an entity having access to a white space database with information on available white space channels,
receiving information indicating a set of available white space channels from the entity,
reserving at least one of channels in the set of available channels for further use, and
providing a sub-set of the channels of the set of available channels to the mobile terminal.

2. The method of claim 1, wherein the mediating node reserves the at least one channel for use by the mediating node and/or other mobile terminals.

3. The method of claim 1, wherein the mobile terminal is a wireless local area network station and the request is received from the mobile terminal when it is not associated to a wireless local area network access point.

4. The method of claim 1, wherein the mediating node is a wireless local area network access point.

5. The method of claim 3, wherein the request from the mobile terminal is according to a generic advertisement service protocol, and the sub-set of the channels of the set of available channels is sent in a generic advertisement service protocol frame.

6. The method of claim 3, wherein the mediating node sends an advertisement element indicating support for white space database access in a beacon or probe response frame.

7. The method of claim 1, wherein the white space channels are television white space channels,
the mediating node generates a white space map comprising the sub-set of the channels, and
the mediating node sends the white space map to the mobile terminal.

8. The method of claim 1, wherein the request to the entity indicates the geographical area for which channels are requested.

9. An apparatus, comprising:
at least one processor; and
at least one memory including computer program code,
the at least one memory and the computer program code configured to, with the at least one processor, cause the apparatus at least to perform:
cause sending of a request for available channels to an entity having access to a white space database with information on available white space channels,
reserve for further use at least one of channels in a set of available white space channels indicated by the entity, and
provide a sub-set of the channels of the set of available channels to a requesting mobile terminal.

10. The apparatus of claim 9, wherein the apparatus is configured to reserve the at least one channel for use by the apparatus and/or other mobile terminals.

11. The apparatus of claim 9, wherein the mobile terminal is a wireless local area network station and the request is received from the mobile terminal when it is not associated to a wireless local area network access point.

12. The apparatus of claim 9, wherein the apparatus is a wireless local area network access point device.

13. The apparatus of claim 12, wherein the request from the mobile terminal is according to a generic advertisement service protocol, and the apparatus is configured to cause sending of the sub-set of the channels of set of available channels in a generic advertisement service protocol frame.

14. The apparatus of claim 12, wherein the apparatus is configured to cause sending of an advertisement element indicating support for white space database access in a beacon or probe response frame.

15. The apparatus of claim 9, wherein the white space channels are television white space channels, and
the apparatus is configured to generate a white space map comprising the sub-set of the channels for the mobile terminal.

16. The apparatus of claim 9, wherein the request to the entity indicates the geographical area for which channels are requested.

17. (canceled)

18. A computer readable storage medium comprising one or more sequences of one or more instructions which, when executed by one or more processors of an apparatus, cause the apparatus to send a request for available channels for an entity having access to a white space database with information on available white space channels,
reserve for further use at least one of channels in a set of available white space channels indicated by the entity, and
provide a sub-set of the channels of the set of available channels to a requesting mobile terminal.
